(19) United States
(12) Patent Application Publication
(10) Pub. No.: US 2018/0096418 A1
(43) Pub. Date: Apr. 5, 2018

(54) PRODUCT MODELING SYSTEM AND METHODS FOR OPERATING SAME

(71) Applicant: Chris Basmadjian, Novi, MI (US)

(72) Inventor: Chris Basmadjian, Novi, MI (US)

(21) Appl. No.: 15/724,179

(22) Filed: Oct. 3, 2017

Related U.S. Application Data
(60) Provisional application No. 62/403,866, filed on Oct. 4, 2016.

(51) Int. Cl. G06Q 30/06; G06Q 30/02; G06T 11/60; G06F 3/0481; G06F 3/0484; G01S 19/42; H04W 4/02

(52) U.S. Cl. CPC G06Q 30/0643; G06Q 30/0205; G06T 11/60; G06T 2210/22; G06F 3/04845; G01S 19/42; H04W 4/02; G06F 3/04817

(57) ABSTRACT

Method and system is disclosed for virtually modeling a product. The method includes displaying a user interface, receiving, in response from a selection by the user, a model product from a plurality of products, the model product associated with a model product image, receiving, in response from a selection by the user, a user image from memory or a database, generating a product-user complication based upon the user image and the model product image, and displaying the selected model product and the selected user image as a product-user compilation.

### CROSS REFERENCE TO RELATED APPLICATIONS

This application claims the benefit of Provisional Application No. 62/403,866 filed on Oct. 4, 2016 which is hereby incorporated herein by reference.

### TECHNICAL FIELD

This disclosure relates to virtual product modeling, and more particularly to systems and methods for virtually modeling products in a generated environment for user evaluation.

### BACKGROUND

The statements in this section merely provide background information related to the present disclosure and may not constitute prior art.

In recent years, the internet and online shopping has replaced physical store shopping and store identification. Many potential customers will locate stores utilizing an online search engine or online store database. This experience is problematic, however, in that many specific services are not listed only broad, general service categories. Online shopping also has the disadvantage that the buyer cannot physically inspect the item.

Therefore, a need exists for buyer's to virtually view and assess a particular product or service and be able to identify or request an available service store or business.

### SUMMARY

Method and system is disclosed for virtually modeling a product. The method includes displaying a user interface, receiving, in response from a selection by the user, a model product from a plurality of products, the model product associated with a model product image, receiving, in response from a selection by the user, a user image from memory or a database, generating a product-user complication based upon the user image and the model product image, and displaying the selected model product and the selected user image as a product-user compilation.

Certain embodiments of the invention include a feature of applying image processing techniques to merge a user image with a model product image.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary modeling system, in accordance with the present disclosure;

FIGS. 2-11 illustrate exemplary user interfaces, in accordance with the present disclosure;

FIG. 12 shows an exemplary process for operating the system, in accordance with the present disclosure;

FIG. 13 shows an exemplary environment, in accordance with the present disclosure;

FIGS. 14-15 show the environment with exemplary products, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

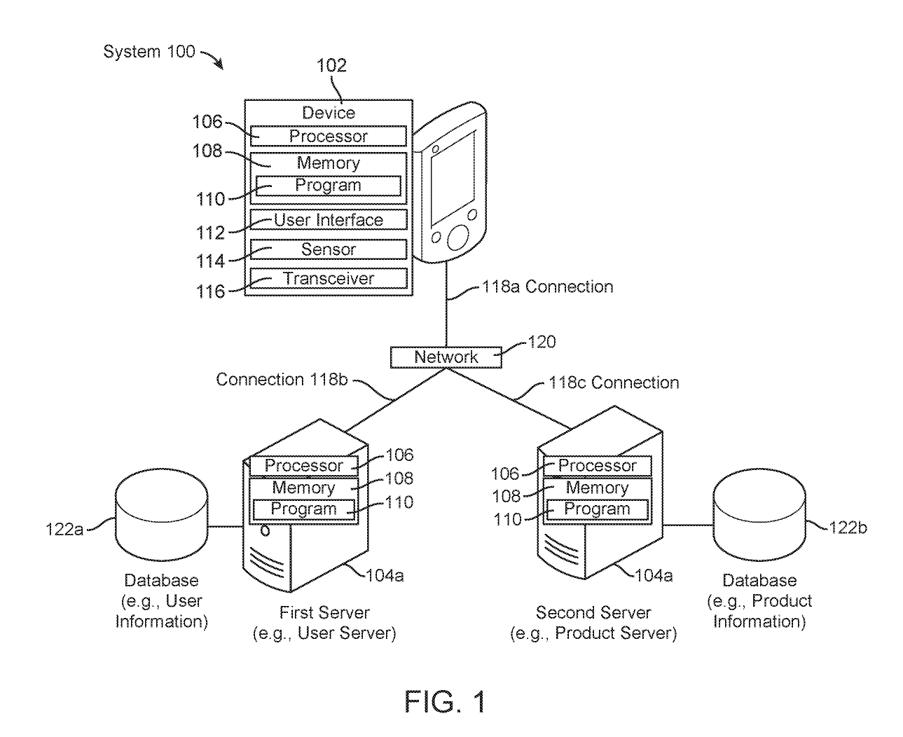

Referring now to the drawings, wherein the depictions are for the purpose of illustrating certain exemplary embodiments only and not for the purpose of limiting the same, FIG. 1 schematically shows an exemplary virtual modeling system 100 that may help implement the methodologies of the present disclosure.

An exemplary system 100 may include a user interface, a hardware processor, and memory having a program communicatively connected to the processor. The processor may provide operations including to select a model product from a plurality of products, select a user image from memory or a database, display the selected model product and the selected user image as a product-user compilation, display product sources of the product-user compilation within a user-predefined proximity to a user location, confirm viewing angles associated with the product-user compilation, display a product location associated with the product-user compilation, and display profile information associated with the product-user compilation. Alternatively, or in addition, the processor may provide operations including capture an image of a product, associate the product image with product source information including a source location, and store the product image and the product source information. Corresponding methods and computer-readable instructions are also contemplated for the operations herein.

FIG. 1 illustrates an exemplary system 100, e.g., for product modeling. System 100 may include one or more of device 102, servers 104 (e.g., a first server 104a such a user server and a second server 104b such as a product server), a processor 106 (e.g., a hardware processor), memory 108, program 110, user interface 112, sensor 114, transceiver 116, connections 118 (e.g., 118a, 118b, and 118c), network 120, and databases 122 (e.g., database 122a having user information and database 122b having product information). The system 100 may take many different forms and include multiple and/or alternate hardware components and facilities. While an exemplary system 100 is shown, the exemplary components illustrated are not intended to be limiting. Indeed, additional or alternative components and/or implementations may be used.

An exemplary system 100 may include a user interface 112, a processor 106, and memory having a program 110 communicatively connected to the processor. The processor 106 by way of user interface 112 may provide operations including to select a model product from a plurality of products, select a user image from memory or a database, display the selected model product and the selected user image as a product-user compilation, display product sources of the product-user compilation within a user-predefined proximity to a user location, confirm viewing angles associated with the product-user compilation, display a product location associated with the product-user compilation, and display profile information associated with the product-user compilation.

As another example, the system 100 may be configured to receive by the user interface 112 first user or product attributes from user inputs of a user, receive by the transceiver 116 second user or product attributes from sensor outputs of one or more of sensors 114, compare by the processor 106 the first and second user or product attributes with a plurality of model products stored on memory 108 or database 122, display by the user interface 112 a subset of the plurality of model products that match the first and second user or product attributes, store on memory 108 or database 122 the matching subset of the plurality of model products, and communicate using the transceiver 116 by way of network 120 the matching subset of model products to server 104 or another device 102.

A user (e.g., a salon owner) may utilize a device 102, by way of processor 106 executing program 110 that is stored on memory 108, to generate a model product (e.g., a model hairstyle) including user or product attributes from at least one of user inputs by way of user interface 112 and sensor outputs by way of sensor 114 (e.g., a camera). Exemplary user attributes may include a user image (e.g., a user face), a user name, a user preference, user location data, and user information (e.g., a location such as an address and contact information such as a phone number). Exemplary product attributes may include a product image (e.g., a hairstyle image), a product source name (e.g., a hair stylist or salon name), a product style (e.g., a hairstyle name), and product source information (e.g., a location such as an address and contact information such as a phone number). For example, the sensor 114 capture a first product attribute including sensor outputs such as a user or product image and user interface 112 may receive a second product attribute including at least one of a user or product source name, a user preference or product style, and user or product source information.

In another example, a user (e.g., a hairstyle customer) may utilize a device 102. The user interface 112 may provide for a selection of a model product from a plurality of products, provide for a selection of a user image from memory or a database, display the selected model product and the selected user image as a product-user compilation, display product sources of the product-user compilation within a user-predefined proximity to a user location, confirm viewing angles associated with the product-user compilation, display a product location associated with the product-user compilation, and display profile information associated with the product-user compilation. The model product may be generated and displayed in response to at least one of user inputs by way of user interface 112 and sensor outputs by way of sensor 114.

The system 100 may include an overall network infrastructure through which the device 102, servers 104a-b, and databases 122a-b may communicate, for example, to transfer user or product attributes between any of device 102, servers 104a-b, and databases 122a-b, e.g., using connections 118. In general, a network (e.g., system 100 or network 120) may be a collection of computing devices and other hardware to provide connections and carry communications.

The device 102 may include any computing device such as include a mobile device, cellular phone, smartphone, tablet computer, next generation portable device, handheld computer, notebook, or laptop. Device 102 may include processor 106 that executes program 110. Device 102 may include memory 108 or may be in communication with databases 122a-b, e.g., to store user or product attributes and program 110. The device 102 may include transceiver 116 that communicates user or product attributes between servers 104a-b, databases 122a-b, and any other device 102.

The servers 104a-b may include any computing system. An exemplary server 104a may include a user server, e.g., for generating and storing one or more user profiles having user attributes for a plurality of users. An exemplary server 104b may a product server, e.g., for generating and storing one or more product profiles having user or product attributes for a plurality of products. The servers 104a-b may be configured to communicatively connect with and transfer information between each other and with respect to the device 102 and databases 122a-b. Servers 104a-b may be in continuous or periodic communication with one or more device 102. Servers 104a-b may include a local, remote, or cloud-based server or a combination thereof and may be in communication with and provide user or product attributes (e.g., as part of memory 108 or databases 122a-b) to any of device 102. The servers 104a-b may further provide a web-based user interface (e.g., an internet portal) to be displayed by user interface 112. The servers 104a-b may communicate the user or product attributes with device 102 using a notification including, for example automated phone call, short message service (SMS) or text message, e-mail, http link, web-based portal, or any other type of electronic communication. In addition, the servers 104a-b may be configured to store user or product attributes as part of memory 108 or databases 122a-b. The servers 104a-b may include a single or a plurality of centrally or geographically distributed servers 104. Servers 104a-b may be configured to store and coordinate user or product attributes with device 102 and databases 122a-b.

The user interface 112 of device 102 may include any display or mechanism to connect to a display, support user interfaces, and communicate user or product attributes within the system 100. Any of the inputs into and outputs from user interface 112 may be included into user or product attributes. The user interface 112 may include any input or output device to facilitate the receipt or presentation of information (e.g., user or product attributes) in audio, visual or tactile form or a combination thereof. Examples of a display may include, without limitation, a touchscreen, cathode ray tube display, light-emitting diode display, electroluminescent display, electronic paper, plasma display panel, liquid crystal display, high-performance addressing display, thin-film transistor display, organic light-emitting diode display, surface-conduction electron-emitter display, laser TV, carbon nanotubes, quantum dot display, interferometric modulator display, and the like. The display may present user interfaces to any user of device 102.

Sensor 114 may include a camera, a microphone, scanner, or a combination thereof. Sensors 114 may be communicatively connected to or part of device 102. Sensor 114 may include a sensor configured to detect and generate one or more sensor outputs associated with user or product attributes. Sensor 114 may include any wired or wireless sensor. Sensor 114 may be configured to communicate one or more sensor outputs (e.g., real-time, near real-time, periodically, or upon request of a user) to the device 102, which may communicate user or product attributes, the sensor outputs, or a combination thereof to any or all of user interface 112 and servers 104a-b.

The device 102 and network 120 may include or utilize location determination technology that enables the determination of location information (e.g., a current geographic position) of the user of device 102 or a product or a product source. Examples of location determination technology may include or utilize, without limitation, global positioning systems (GPS), indoor positioning system, local positioning system, mobile phone tracking, and cellular triangulation. Device 102 may determine location in conjunction with network 120. The device 102 may be configured to provide a current geographic position of device 102, for example, to provide the user location. In addition, the device 102 may be configured to provide a current geographic position of a product or a product source, for example, to provide the product location.

The connections 118 may be any wired or wireless connections between two or more endpoints (e.g., devices or systems), for example, to facilitate transfer of user or product attributes. Connection 118 may include a local area network, for example, to communicatively connect the device 102 with network 120. Connection 118 may include a wide area network connection, for example, to communicatively connect servers 104a-b with network 120. Connection 118 may include a radiofrequency (RF), near field communication (NFC), Bluetooth®, Wi-Fi, or a wired connection, for example, to communicatively connect the device 102 and sensors 103.

Any portion of system 100, e.g., device 102 and servers 104a-b, may include a computing system and/or device that includes a processor 106 and a memory 108. Computing systems and/or devices generally include computer-executable instructions, where the instructions may be executable by one or more devices such as those listed below. Computer-executable instructions may be compiled or interpreted from computer programs created using a variety of programming languages and/or technologies, including, without limitation, and either alone or in combination, Java™, C, C++, Visual Basic, Java Script, PHP, SQL, PL/SQL, Shell Scripts, etc. The system 100, e.g., device 102 and servers 104a-b may take many different forms and include multiple and/or alternate components and facilities, as illustrated in the Figures further described below. While exemplary systems, devices, modules, and sub-modules are shown in the Figures, the exemplary components illustrated in the Figures are not intended to be limiting. Indeed, additional or alternative components and/or implementations may be used, and thus the above communication operation examples should not be construed as limiting.

In general, computing systems and/or devices (e.g., device 102 and servers 104a-b) may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing systems and/or devices such as device 102 and servers 104a-b may include, without limitation, mobile devices, cellular phones, smart-phones, super-phones, tablet computers, next generation portable devices, mobile printers, handheld computers, notebooks, laptops, secure voice communication equipment, networking hardware, computer workstations, or any other computing system and/or device.

Further, processors such as processor 106 receive instructions from memories such as memory 108 or databases 122a-b and execute the instructions, thereby performing one or more processes, including one or more of the processes described herein. Such instructions and other user or product attributes may be stored and transmitted using a variety of computer-readable mediums (e.g., memory 108 or databases 122a-b). Processors such as processor 106 may include any computer hardware or combination of computer hardware that is configured to accomplish the purpose of the devices, systems, and processes described herein. For example, the processor 106 may be any one of, but not limited to single, dual, triple, or quad core processors (on one single chip), graphics processing units, visual processing units, and virtual processors.

A memories such as memory 108 or databases 122a-b may include, in general, any computer-readable medium (also referred to as a processor-readable medium) that may include any non-transitory (e.g., tangible) medium that participates in providing user or product attributes or instructions that may be read by a computer (e.g., by the processors 106 of the device 102 and servers 104a-b). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including radio waves, metal wire, fiber optics, and the like, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Further, databases, data repositories or other user or product attributes stores (e.g., memory 108 and databases 122a-b) described herein may generally include various kinds of mechanisms for storing, providing, accessing, and retrieving various kinds of user or product attributes, including a hierarchical database, a set of files in a file system, an application database in a proprietary format, a relational database management system (RDBMS), etc. Each such user or product attributes store may generally be included within (e.g., memory 108) or external (e.g., databases 122a-b) to a computing system and/or device (e.g., device 102 and servers 104a-b) employing a computer operating system such as one of those mentioned above, and/or accessed via a network (e.g., system 100 or network 120) or connection in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above. Memory 108 and databases 122a-b may be connected to or part of any portion of system 100.

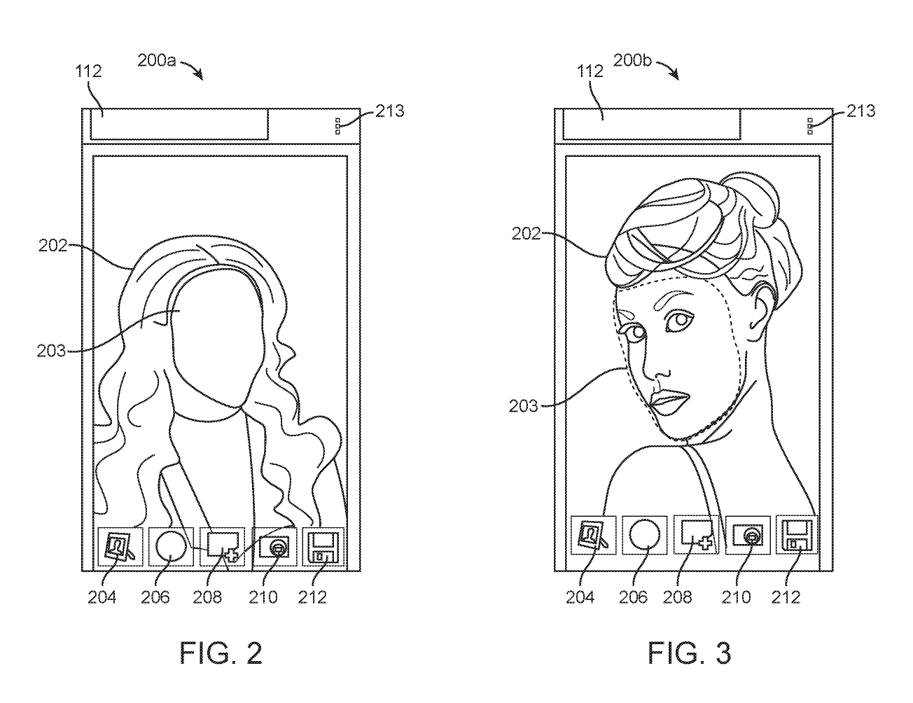

FIGS. 2 and 3 illustrate respective display screens 200a and 200b with a user interface 112, e.g., for displaying a user image with respect to a model product so as to form a user-product compilation. The user interfaces may be displayed on a mobile device, for example. As shown in FIG. 2, the user interface 112 may display a product image 202 (e.g., of a hairstyle) with a cutout 203. The cutout is located in an area associated with a human face. As shown in FIG. 3, the user interface 112 may display the user image (e.g., a user face received by way of sensor 114 or stored on memory 108 or database 122) in the cutout 203. In this way, the user's face may be displayed with the product image for assessment by the user.

The user interface 112 may include a product selection 204 (e.g., displaying and providing selection of products such as hairstyles for selection by the user), a maps selection 206 (e.g., displaying and providing selection of a geometric location on a map for directions to a product source of a product), an image selection 208 (e.g., displaying and providing selection of images stored on memory 108 or database 122), a sensor function selection 210 (e.g., displaying and providing selection of sensor functions such as camera functions), a save selection 212 (e.g., displaying and saving a user face with the product such as a hairstyle), and additional selections 213 (e.g., providing appointment requests and program settings associated with the product).

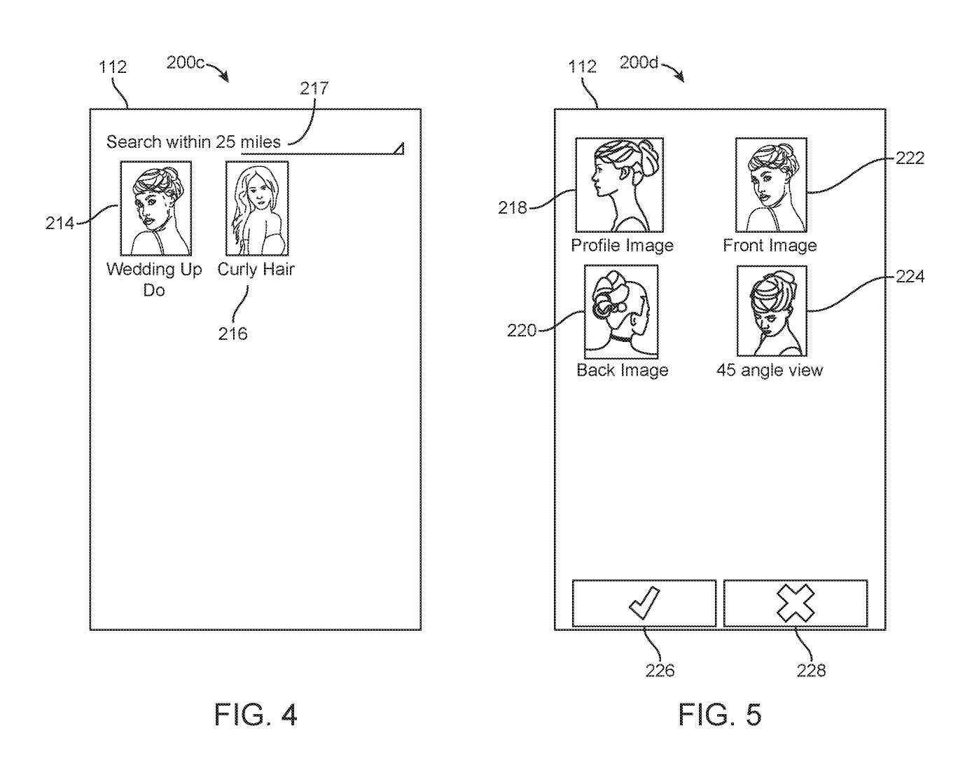

FIG. 4 illustrates display screen 200c with user interface 112, e.g., for displaying products in proximity to the user. User interface 112 may be configured to display one or more products 214, 216 (e.g., product types such as hairstyles including “wedding up do,” “curly hair,” etc.) having a product location within a user-predefined distance 217 (e.g., 25 miles) from the user location. User interface 112 may be configured to allow a product selection by the user.

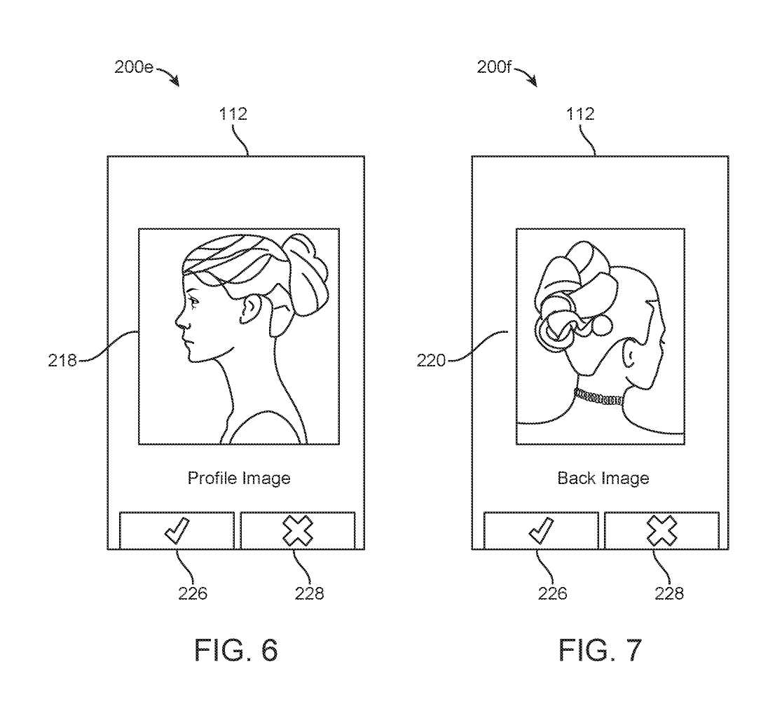

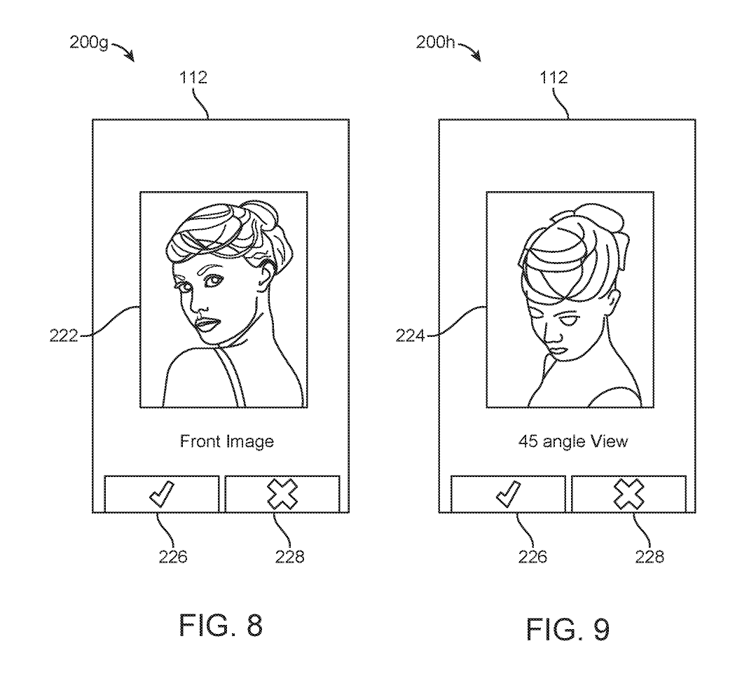

FIGS. 5-9 illustrate respective display screens 200d, 200e, 200f, 200g, and 200h with user interface 112, e.g., for displaying one or a plurality of viewing angles in response to the product selection. The user interface 112 may include viewing angle 218 (e.g., profile image), viewing angle 220 (e.g., back image), viewing angle 222 (e.g., front image), and viewing angle 224 (e.g., 45 degree angle view), e.g., to allow the user to understand what the product (e.g., hairstyle) looks like from various views. The user interface 112 may include an accept option 226 (e.g., accepts and returns to the home screen) and rejection option 228 (e.g., rejects and returns to product selection screen).

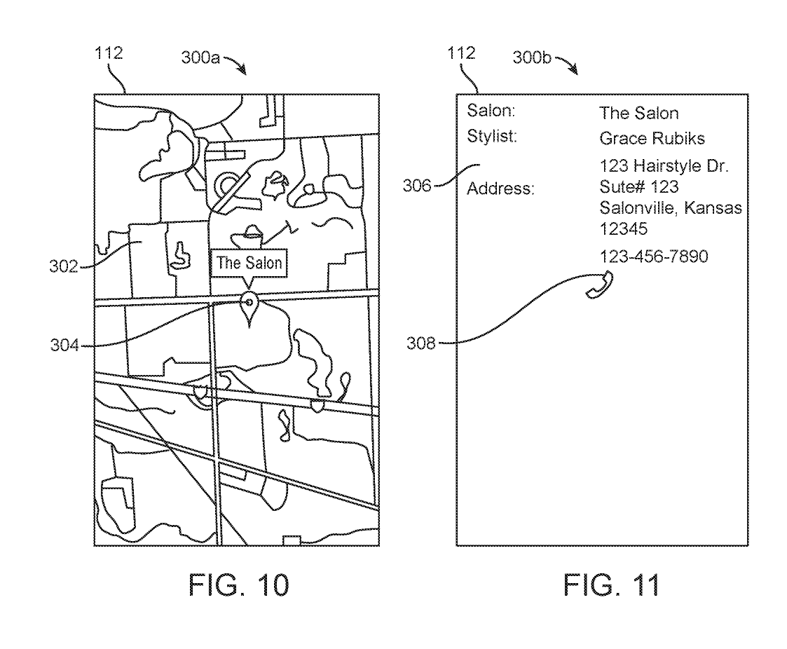

FIG. 10 illustrates display screen 300a with user interface 112, e.g., for displaying product location in response to the product selection. User interface 112 may include a map 302 with a product location 304, e.g., displayed as a pinpoint of a product source (e.g., a salon) associated with a product selection (e.g., a hairstyle). The user interface 112 may include a user or product location including geographic location such an address or GPS coordinates. User interface 112, by way of a program 110 or a third-party map program, may also be configured to provide travel directions between the user location and the product location.

FIG. 11 illustrates display screen 300b with user interface 112, e.g., for displaying profile information in response to the product selection. User interface 112 may have profile information including product information such as a product source name (e.g., a stylist and/or salon name), a product location (e.g., an address for the product or product source), and contact information (e.g., a phone number or email address). User interface 112 may also be configured to initiate a call, email, or text message to the product source (e.g., the salon or directly to the stylist).

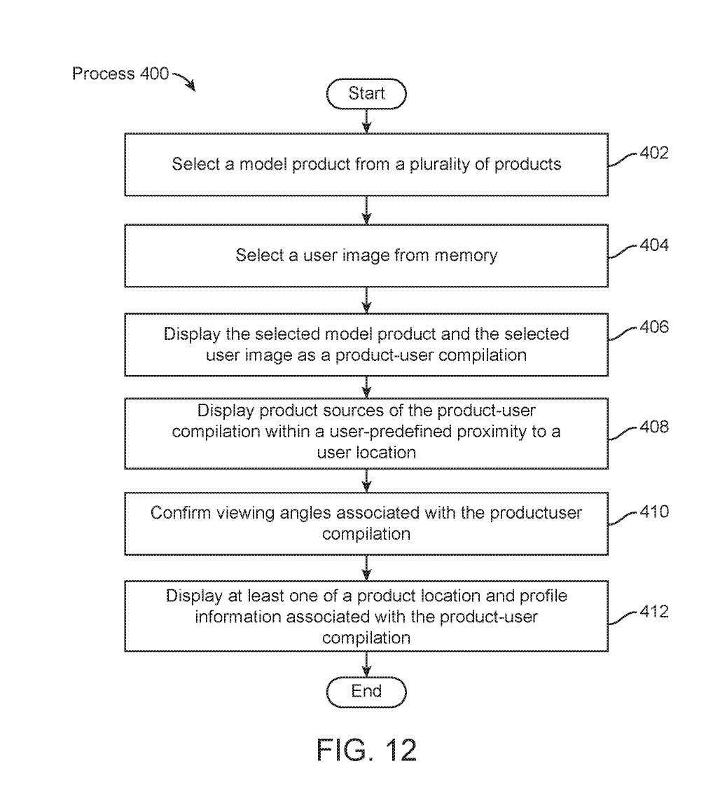

FIG. 12 illustrates an exemplary process 400. Process 400 may take many different forms and include multiple and/or alternate components and facilities. While an exemplary process 400 is shown the figure, the exemplary components illustrated are not intended to be limiting. Indeed, additional or alternative components and/or implementations may be used.

At block 402, user interface 112 may display and provide for the selection of a model product from a plurality of products. In one embodiment, the products are associated with different hairstyles. In one embodiment, the model product includes a portion of the image that is associated with no image data, i.e., a blank area such as a “cutout” portion with null pixel information. The products and images associated with the products may be provided by business owners. For example, a salon owner, or hair stylists, may upload various images for different products. In one embodiment, the salon owner or hair stylists may select from a number of predefined hair styles for association with their offerings.

At block 404, user interface 112 may display and provide for the selection of a user image from memory. In one embodiment, the user uploads an image associated with their likeness or the likeness of another. In one embodiment, the user image is acquired via sensor which may be a camera. In one embodiment, the user image is acquired from a database associated with a social networking service.

At block 406, user interface 112 may display the selected model product and the selected user image as a product-user compilation. In one embodiment, the system 100 simply superimposes a cropped portion of the user image onto the cutout 103. In one embodiment, the system 100 superimposes the image associated with the selected model product over the user image. In this way, no or minimal image processing techniques are used to obtain a product-user compilation. In one embodiment, the user may move or manipulate either or both the image associated with the selected product model and the user image. In this way, the user may manually align the either the image associated with the selected product model with the user image or vice versa.

In one embodiment, the system 100 utilizes known facial recognition and/or facial detection techniques to identify and crop a user's face from the user image before generating the product-user compilation.

At block 408, user interface 112 may display and provide for the selection of product sources of the product-user compilation within a user-predefined proximity to a user location. The sources may be listed by service providers. For example, a service provider may be associated with one or more product or service listings. In this way, a service provider may select specific goods and/or services that they are capable of providing at a desired level of proficiency. This capability may promote development of specialized service providers or simply promote efficiency through identification of expert service providers for a specific product.

At block 410, user interface 112 may display and provide for the confirmation of viewing angles associated with the product-user compilation. In this way, the user is presented with an opportunity to confirm that the product or service is the desired one.

At block 412, user interface 112 may display at least one of a product location and profile information associated with the product-user compilation. The product location and profile information may be selected, in part, from willing travel proximity information obtained from the user. For example, a user may be willing to travel 15 miles from their current location or location associated with the user information, e.g., an address. In this way, the system 100 returns product location and profile information relevant to the user's proximity.

After block 412, the process 400 ends. Additionally, the order in which a particular method occurs may or may not strictly adhere to the order of the corresponding steps shown. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

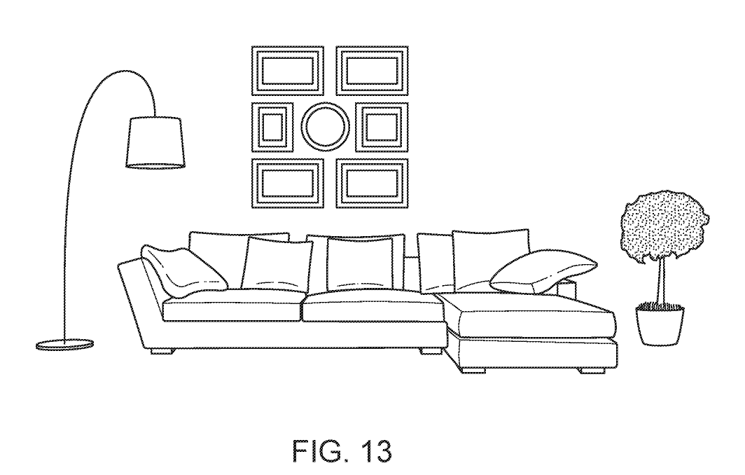

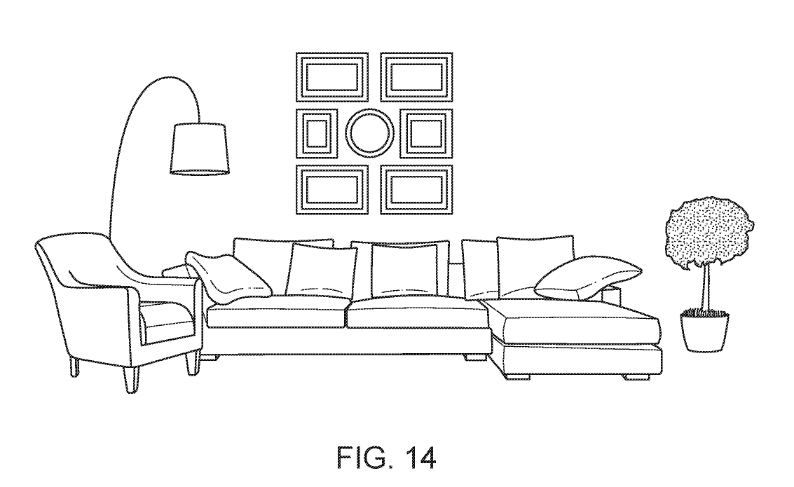

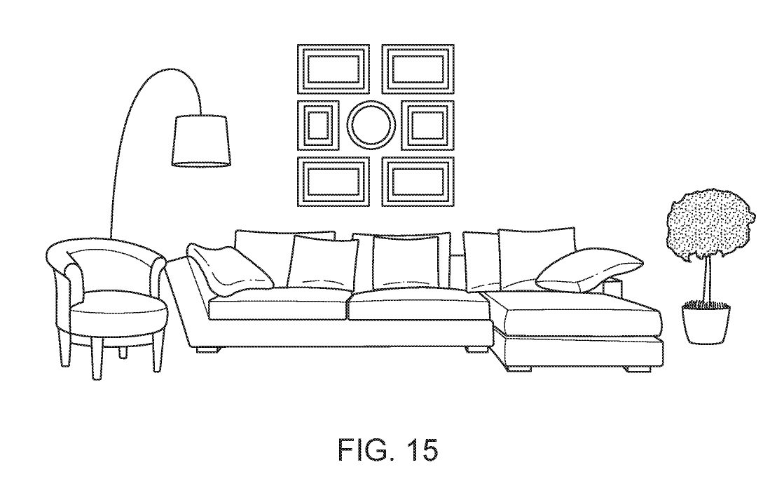

Upon a careful reading of the teachings here, one skilled in the art will readily ascertain that the teachings may be applied more generally to other products and services. For example, FIGS. 13-15 show the teachings applied to a virtual furniture shopping application. FIG. 13 shows an exemplary environment. Similar to the abovementioned methods, a user may select a furniture piece for virtual viewing within this environment. The furniture piece may be displayed in a user interface for selection. In one embodiment, the furniture pieces and environment are 3D modeled so that a user may selectively place the selected furniture piece within the environment. In doing so, the user may then manipulate the furniture piece within the environment by, for example, rotating the piece, enlarging the piece, changing color, etc. FIGS. 14-15 show the environment with different selected exemplary products.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A method for virtually modeling of a product, the method comprising:
displaying a user interface;
receiving, in response from a selection by a user, a model product from a plurality of products, the model product associated with a model product image;
receiving, in response from a selection by the user, a user image from memory or a database;
superimposing the selected product model over the user image at an image position selected by the user; and
displaying the selected model product and the selected user image as a product-user compilation.

2. The method of claim 1, further comprising:
displaying product sources of the product-user compilation within a user-predefined proximity to a user location.

3. The method of claim 1, further comprising:
confirming, in response from a selection by the user, viewing angles associated with the product-user compilation.

4. The method of claim 3, further comprising:
determining a location of the user;
receiving, from the user, a willing travel proximity; and
displaying a product location associated with the product-user compilation based upon the location of the user and the willing travel proximity.

5. The method of claim 4, further comprising:
displaying profile information associated with the product-user compilation.

6. The method of claim 1, wherein the user image is acquired via a camera.

7. A method for virtually modeling of a product, the method comprising:
displaying a user interface;
receiving, in response from a selection by a user, a model product from a plurality of products, the model product associated with a model product image;
receiving, in response from a selection by the user, a user image from memory or a database;
using image processing techniques to crop a portion of the user image associated with a face of the user and superimpose the portion on the model product image; and
displaying the selected model product and the selected user image as a product-user compilation.

8. The method of claim 7, further comprising:
displaying product sources of the product-user compilation within a user-predefined proximity to a user location.

9. The method of claim 7, further comprising:
confirming, in response from a selection by the user, viewing angles associated with the product-user compilation.

10. The method of claim 9, further comprising:
determining a location of the user based upon global positioning systems (GPS) data;
receiving, from the user, a willing travel proximity; and
displaying a product location associated with the product-user compilation based upon the location of the user and the willing travel proximity.

11. The method of claim 10, further comprising:
displaying profile information associated with the product-user compilation.

12. The method of claim 7, wherein the user image is acquired via a camera.

13. A virtual modeling system, comprising:
a user interface;
a processor and a memory having a program communicatively connected to the processor, the processor providing operations including:
displaying a user interface;
receiving, in response from a selection by the user, a model product from a plurality of products, the model product associated with a model product image;
receiving, in response from a selection by the user, a user image from memory or a database;
generating a product-user compilation based upon the user image and the model product image; and
displaying the selected model product and the selected user image as a product-user compilation.

14. The system of claim 13, further comprising:
displaying product sources of the product-user compilation within a user-predefined proximity to a user location.

15. The system of claim 14, further comprising:
confirming, in response from a selection by the user, viewing angles associated with the product-user compilation.

16. The system of claim 15, further comprising:
determining a location of the user based upon global positioning systems (GPS) data;
receiving, from the user, a willing travel proximity; and
displaying a product location associated with the product-user compilation based upon the location of the user and the willing travel proximity.

17. The system of claim 16, further comprising:
displaying profile information associated with the product-user compilation.

18. The system of claim 13, wherein the user image is acquired via a camera.

19. The system of claim 13, wherein the generating a product-user compilation based upon the user image and the model product image is executed using facial detection and image merging techniques.
